(19) United States
(12) Patent Application Publication
(10) Pub. No.: US 2005/0088399 A1
(43) Pub. Date: Apr. 28, 2005

(54) Direct-light illuminating backlight unit with shielding mask for a liquid crystal display

(76) Inventors: John C. Pan, Taichung (TW); Chih-Kuang Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/692,852

(22) Filed: Oct. 27, 2003

(51) Int. Cl. G09G 3/36

(52) U.S. Cl. 345/102

(57) ABSTRACT

A direct-light illuminating backlight unit with shielding mask for a liquid crystal display has a case with a back, at least one lamp mounted in alignment with the back, and at least one shielding mask mounted in the case in front of the corresponding lamp. The case has a front opening that has at least one brighter region immediately in front of the lamp and at least one dimmer region away from the lamp. The shielding mask is made of opaque material and has openings to let light through. The shielding mask allows only some light radiated forward from the lamp to pass through to the front opening, so that the luminance of the brighter area is reduced and the brightness of the emitting light at the front opening is more homogenous.

### BACKGROUND OF THE INVENTION

1. Field of the Invention

The present invention relates to a direct-light illuminating backlight unit with shielding mask for a liquid crystal display (LCD), and more specifically to an illuminating backlight unit providing a planar light source with homogenous luminance to improve the image quality of an LCD.

2. Description of Related Art

Liquid crystal displays (LCDs) are lightweight, slim and do not emit harmful radiation, etc. so the LCD is becoming more popular than the CRT display. The LCD basically has a liquid crystal panel and an illuminating backlight unit. Since the liquid crystal panel cannot emit light, the illuminating backlight unit is a necessary element of the LCD.

There are two types of illuminating backlight unit, generally speaking, the edge-light backlight unit and the direct-light backlight unit. The edge-light units are generally slimmer in size. However, the direct-light units have other advantages, such as higher brightness and better brightness uniformity.

With reference to FIG. 7, the edge-light backlight unit comprises a tubular lamp (60), a reflective sheet (62), a light guide plate (61) and an optical assembly (not numbered). The tubular lamp (60) is mounted inside a reflector (601). The light guide plate (61) has an edge (not numbered) exposed to the tubular lamp (60). The light guide plate (61) is located between the optical assembly and the reflective sheet (62). The reflector (601) projects light radiated from the tubular lamp (60) into the light guide plate (61). The light guide plate (61) is configured to transmit light from the tubular lamp (60) across the viewing area and, with the help of the reflective sheet, effectively deflect light towards the optical assembly. The optical assembly is composed of a diffuser sheet (63) and prism sheets (64) and is located between a liquid crystal panel (50) and a light guide plate (61). When the light passes through the optical assembly, the light is smeared and dispersed, and forms a uniform planar light source for the liquid crystal panel (50).

In the edge-light backlight unit, tubular lamp is mounted at the edge of the light guide plate so the illuminating backlight unit is slim, generally speaking. However, for large size LCDs, the edges of a light guide plate does not provide enough light entrance area for forming a bright enough planar illuminating surface. Especially for applications of a LCD TV, say for example.

With reference to FIG. 8, a conventional direct-light backlight unit in accordance with the prior art comprises a case (70), multiple tubular lamps (71) and a diffuser plate (72). The case (70) has a back (701) and a front opening (702). The tubular lamps (71) are mounted inside the case, and align with the back (701), as illuminating sources. The front opening (702) is covered by a diffuser plate (72) to disperse and smear the emitting light from the lamps, and to make it a homogeneous planar illuminating unit.

Without proper treatment with the diffuser plate (72), the lamps (71) would be clearly visible from the backlight unit. Specifically, brighter areas (not numbered) correspond to the lamps (71), and dimmer areas (not numbered) exist between adjacent lamps (71). Therefore, the diffuser plate (72) must be mounted on the case (70) over the opening (702). The diffuser plate (72), like a screen, can disperse the light from multiple tubular lamps (71) evenly when the diffuser plate is far enough from the tubular lamps (71). If the diffuser plate (72) is placed too close to the lamps (71), the diffuser plate cannot disperse the light properly, thus the bright and dim areas are clearly visible. Therefore, the direct-light backlight unit cannot be made to be slim.

To further increase the brightness (or luminance) of the planar light source, the back (701) of the case (70) is covered with a highly reflective layer (703) to redirect part of the light that radiates backwards from the tubular lamps (71) towards the front. The reflective layer (703) does not, however, discriminatingly project light towards dimmer areas between the tubular lamps (71). With reference to FIG. 6A, the brightness difference at the front opening (702) is still obvious.

Thus concluding from above, the direct-light backlight units can provide large size LCDs with high brightness. However, the multiple tubular lamps (straight or looped in shape) emit light radiantly. Hence, in the viewing area on the display where is direct in front of the lamps forms a brighter region, while, area in between the lamps forms a dimmer region. The unevenly distributed brightness across the viewing area of a liquid crystal display has an adverse effect on the quality of image shown.

The present invention provides a direct-light illuminating backlight unit for a liquid crystal display to mitigate or obviate the aforementioned problems.

### SUMMARY OF THE INVENTION

An objective of the present invention is to provide a planar, direct-light illuminating backlight unit with homogenous brightness to increase the image quality of a liquid crystal display.

Another objective of the present invention is to provide a low profile, slim direct-light illuminating backlight unit.

Other objectives, advantages and novel features of the invention will become more apparent from the following detailed description when taken in conjunction with the accompanying drawings.

### BRIEF DESCRIPTION OF THE DRAWINGS

FIG. 1 is a partial cross-sectional view of a first embodiment of an illuminating backlight unit and a separated liquid crystal panel in accordance with the present invention;

FIG. 2 is a partial cross-sectional view of a second embodiment of an illuminating backlight unit and a separated liquid crystal panel in accordance with the present invention;

FIG. 3 is showing traces of light emitting from lamps as in the illuminating backlight unit of that shown in FIG. 2;

FIG. 4 is an illustration of a shielding mask of an illuminating backlight unit in accordance with the present invention, showing pattern of through holes for light emitting;

FIGS. 5A to 5D are bottom views of the illuminating backlight unit with lamp arrangements in accordance with the present invention;

FIG. 6A is a plot of luminance across a distance perpendicular to the lamps in direction of a direct-light backlight unit without reflective protrusion on the back reflective surface;

FIG. 6B is a plot of luminance across a distance perpendicular to the lamps in direction of a direct-light backlight unit with reflective protrusion on the back reflective surface;

FIG. 7 is a cross-sectional view of an edge-light backlight unit assembly with a liquid crystal panel in accordance with the prior art; and

FIG. 8 is an illustration of a direct-light backlight unit in accordance with the prior art.

### DETAILED DESCRIPTION OF THE PREFERRED EMBODIMENT

A direct-light illuminating backlight unit in accordance with the present invention uses a shielding mask to reduce brightness in the region that is immediately in front of the light-emitting sources or lamps. Therefore, the backlight unit has homogenous luminance across the viewing area.

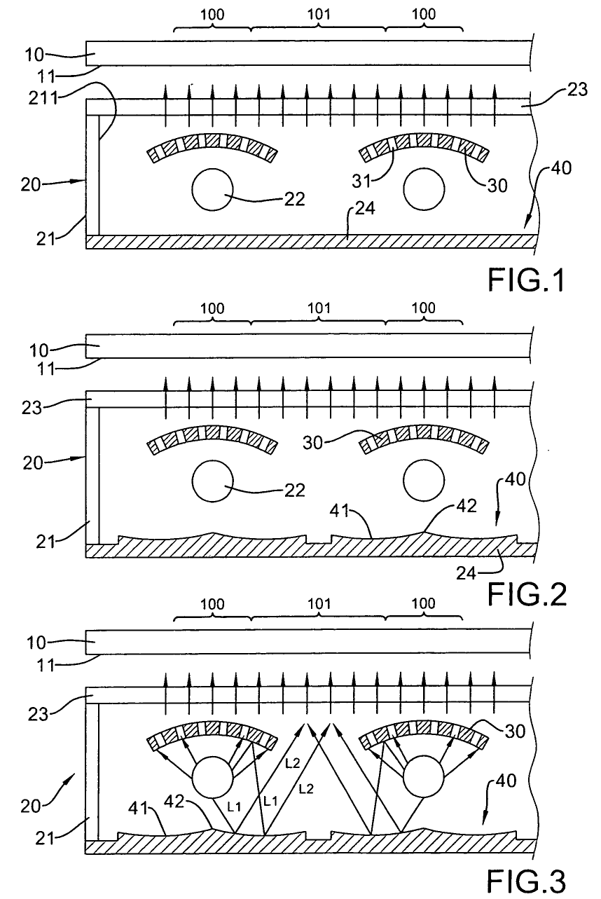

With reference to FIG. 1, a first embodiment of the direct-light backlight unit in accordance with the present invention attaches to a rear face (11) of a liquid crystal panel (10). The illuminating backlight unit has a thickness (not numbered), a case (20), at least one light-emitting source (22), at least one shielding mask (30), a light emitting face (not numbered) and optionally a diffuser plate (23).

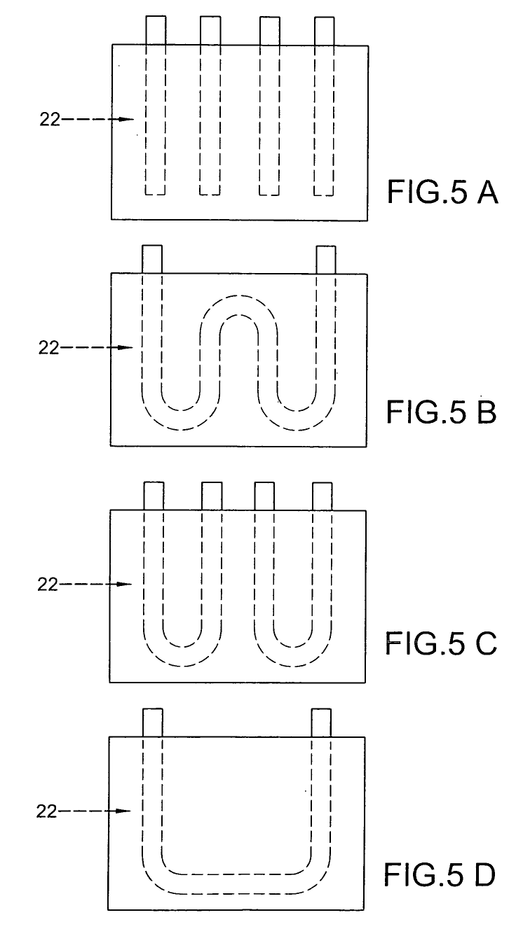

The case (20) has a frame (21), a back (24), and a front opening (211). The light emitting source (22) is mounted inside the case (20) align with the back (24), and a liquid crystal panel (10) is mounted in front of the illuminating backlight unit over the front opening (211) of the case (20). With further reference to FIGS. 5A to 5D, the light-emitting source (22) can be a straight tubular lamp or looped tubular lamp. The looped tubular lamp can be either in W shape, U shape, etc. On the light emitting face of a backlight unit, when the lamp (22) radiates light, the further away from the lamp has the lower illumination, thus forms uneven brighter regions (100) and dimmer regions (101). The brighter regions (100) are areas immediately in front of the lamps (22), and the dimmer regions are areas in between the lamps (101).

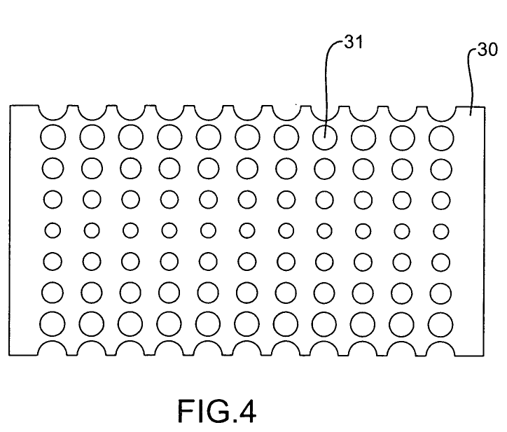

Each shielding mask (30) is mounted in the case (20) in front of the lamp (22). With further reference to FIG. 4, the shielding mask (30) has a pattern of opening that allow light to be emitted from the otherwise opaque mask. Wherein the region immediately in front of the lamp has smaller opening ratio and hence higher blockage to light. Furthermore, the region away from the lamp has lager opening ratio and hence lower blockage to light. Thus, the mask reduces the unevenness of luminance between the brighter region and the dimmer region. Furthermore, the opening pattern of the shielding mask could be a group of through holes. The holes (31) immediately in front of the lamp (22) are small and increase in size, as they get further away from the lamp, corresponding to a reducing incident illumination. The shielding mask (30) can be either curved or flat, and could be made of opaque material with high reflectance. The reflective inner surface of the shielding mask can reflect part of the light that come directly radiating from the lamps and recycle the light towards the back reflective layer (24) to be redirect towards the dimmer regions.

To further adjust the distribution of luminance across the light-emitting face (viewing area), a diffuser plate (23) may be mounted on the frame (21) over the front opening (211) to disperse the emitting light evenly. Therefore, the illuminating backlight unit can provide a planar light source with homogenous luminance. Since the luminance differences in between the brighter areas (100) and the dimmer areas (101) on the light emitting face is decreased by the shielding mask (30), the diffuser plate (23) can be mounted closer to the lamp (22), and thus reduces the thickness of the illuminating backlight unit. In addition, a diffuser sheet (not shown) or prism sheets (not shown) can be laid on top to the diffuser plate (23) to further disperse the emitting light from the backlight unit.

With reference to FIG. 2, a second embodiment of the illuminating backlight unit is brighter than that of the first embodiment. The illuminating backlight unit further comprises a reflective layer (not numbered) on the bottom (24) of the case (20). The reflective layer is mounted on or formed integrally with the bottom (24) and is composed of multiple reflective protrusions (40). Each reflective protrusion (40) corresponds to a lamp (22) and has one salient (42) and two inclined faces (41). The salient (42) is aligned with the lamp (22), and each inclined face (41) project light onto an adjacent dimmer area (101). Each inclined face (41) can be a flat, concave or convex surface.

With reference to FIG. 3, light (L1) radiated backward from the lamp (22) and the shielding mask (30) strikes the reflective layer and radiates forward as reflected light (L2). The reflected light (L2) is projected towards the dimmer area (101) by the inclined faces (41), which increases the luminance of the dimmer area. Therefore, the light radiates from the lamp (22) can be more effectively and evenly emitting through the front opening (light-emitting face) of the case.

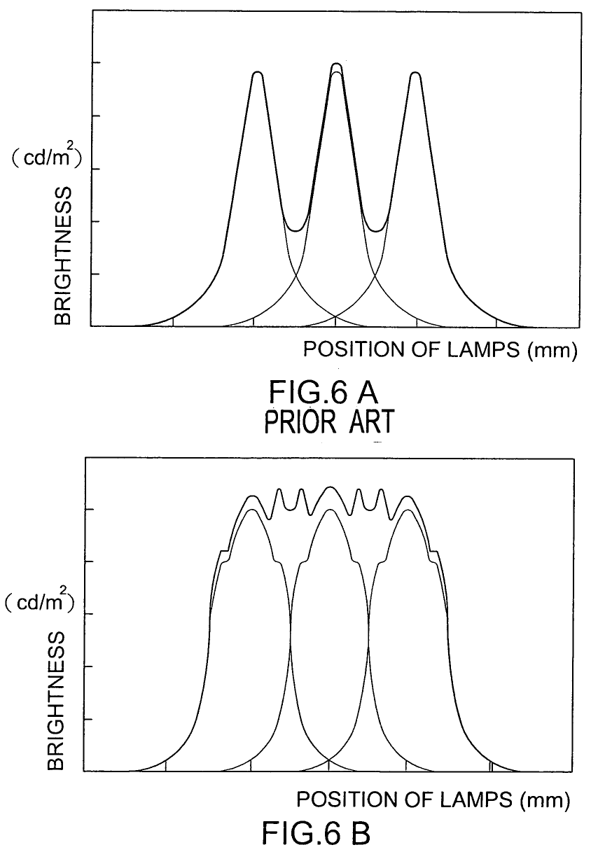

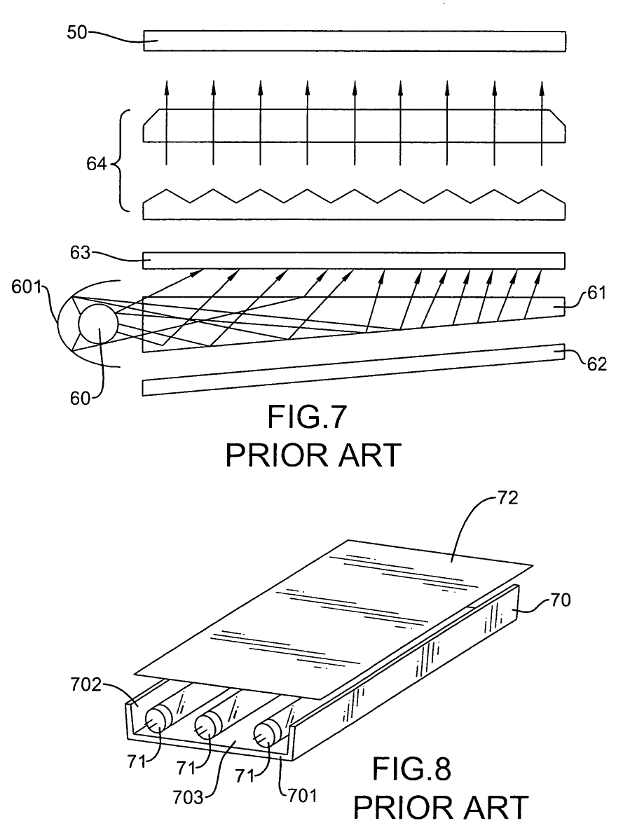

With reference to FIGS. 6A and 6B, the illuminating backlight unit in accordance with the present invention uses the reflective layer, so the luminance distribution has shallower nulls than the prior art of conventional backlight.

Based on the forgoing description, the backlight illuminating backlight unit in accordance with the present invention uses the shielding mask to reduce the brightness of the brighter areas and to decrease the difference of luminance in between the brighter and dimmer areas. In addition, the shielding mask can further reflect a portion of the light radiated from lamp towards the brighter areas back to the reflective layer on the back and then project the reflected light towards the dimmer areas. Therefore, a homogenous luminance distribution is achieved across the light-emitting face (front opening). Further, the brightness of the emitting light is first being averaged by the shielding mask and then the reflective layer on the back, so the distance between the diffuser plate and the lamp can be reduced, and thus reduces the total thickness of the illuminating backlight unit.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A direct-light illuminating backlight unit with shielding mask for a liquid crystal display, comprising
a case having a front opening as a light-emitting face, a frame and a back connected to the frame, wherein the light-emitting face has at least one brighter region and at least one dimmer region;
at least one light-emitting source mounted inside the case align with the back, wherein the at least one brighter region is immediately in front of the light-emitting source, and the at least one dimmer region is away from the light-emitting source; and
at least one shielding mask mounted in the case in front of the light-emitting source, wherein each shielding mask has a pattern of opening that allow light to be emitted from the otherwise opaque mask, wherein at least one region immediately in front of the light-emitting source has smaller opening ratio and hence higher blockage to the light, wherein at least one region away from the light-emitting source has lager opening ratio and hence lower blockage to the light, and thus reduces uneven luminance between the at least one brighter region and the at least one dimmer region.

2. The illuminating backlight unit as claimed in claim 1, further comprising a reflective layer formed on the back to reflect light radiated backward from each light-emitting source to the front opening.

3. The illuminating backlight unit as claimed in claim 2, wherein the reflective layer is composed of multiple reflective protrusions, each protrusion having two inclined faces and a salient aligned with the corresponding light-emitting sources, wherein each inclined face project reflected light onto an adjacent dimmer region.

4. The illuminating backlight unit as claimed in claim 3, wherein the reflective layer is formed integrally with the back.

5. The illuminating backlight unit as claimed in claim 1, wherein the shielding mask is curved.

6. The illuminating backlight unit as claimed in claim 1, wherein the shielding mask is flat.

7. The illuminating backlight unit as claimed in claim 1, wherein the opening pattern of the shielding mask is a group of through holes.

8. The illuminating backlight unit as claimed in claim 1, wherein the at least one light-emitting source is a tubular lamp.

9. The illuminating backlight unit as claimed in claim 1, wherein the at least one light-emitting source is a straight tubular lamp.

10. The illuminating backlight unit as claimed in claim 1, wherein the at least one light-emitting source is a looped tubular lamp in U shape.

11. The illuminating backlight unit as claimed in claim 1, wherein the at least one light-emitting source is a looped tubular lamp in W shape.

12. The illuminating backlight unit as claimed in claim 1 further comprising a diffuser plate mounted at the front opening of the case in front of the shielding mask.

13. The illuminating backlight unit as claimed in claim 12 further comprising a diffuser sheet laid on top the diffuser plate.

14. The illuminating backlight unit as claimed in claim 12 further comprising a prism sheet laid on top the diffuser plate.
